(19) United States
(12) Patent Application Publication
(10) Pub. No.: US 2026/0084933 A1
(43) Pub. Date: Mar. 26, 2026

(54) ELEVATOR SYSTEM WITH A GUIDING STRUCTURE COMPRISING AT LEAST ONE GUIDE RAIL BRACKET

(71) Applicant: Otis Elevator Company, Farmington, CT (US)

(72) Inventor: Lucia Fito, Leganes (ES)

(21) Appl. No.: 19/339,898

(22) Filed: Sep. 25, 2025

(30) Foreign Application Priority Data
Sep. 26, 2024 (EP) 24383034.6
Nov. 27, 2024 (EP) 24383286.2

(51) Int. Cl. B66B 11/00; B66B 7/06; B66B 9/00; B66B 19/00

(52) U.S. Cl. CPC B66B 11/0045; B66B 7/06; B66B 9/00; B66B 19/005

(57) ABSTRACT

An elevator system includes at least one elevator car that is configured for traveling in a hoistway along a longitudinal direction (L) between a plurality of landings; at least one tension member for supporting and driving the at least one elevator car; and a guiding structure. The guiding structure comprises at least two guide rails provided in the hoistway for guiding the movement of elevator car and/or of a counterweight in the hoistway; and at least one guide rail bracket extending along a transverse direction between two of the at least two guide rails for the coupling two guide rails with each other. The at least one guide rail bracket includes a recess that allows the at least one tension member to pass the at least one guide rail bracket by extending through the recess.

### FOREIGN PRIORITY

This application claims priority to European Patent Application No. 24383034.6, filed Sep. 26, 2024, and European Patent Application No. 24383286.2, filed Nov. 27, 2024, and all the benefits accruing therefrom under 35 U.S.C. § 119, the contents of which in their entirety are herein incorporated by reference.

### TECHNICAL FIELD OF INVENTION

The invention relates to an elevator system with a guiding structure comprising at least one guide rail bracket.

### BACKGROUND OF THE INVENTION

An elevator system comprises at least one elevator car that is configured for moving along a hoistway extending between a plurality of landings and an elevator machine for driving the at least one elevator car. The elevator system further comprises at least one tension member for suspending the at least one elevator car and for mechanically coupling the at least one elevator car with the elevator machine. The elevator system may optionally comprise at least one counterweight that is coupled to the at least one tension member for moving concurrently with the elevator car in the opposite direction.

The elevator system may further comprise a guiding structure including guide members, in particular guide rails, that are configured for guiding the movement of the at least one elevator car and/or the at least one counterweight along the hoistway.

The elevator system may in particular comprise elevator car guide rails for guiding the movement of the at least one elevator car and/or counterweight guide rails for guiding the movement of the at least one counterweight.

The guiding structure may further include at least one guide rail bracket extending along a transverse direction between two of the at least two guide rails for stabilizing the guiding structure by coupling the two guide rails with each other.

In a compact configuration of the elevator system, in which the elevator machine, the guide rails and the at least one guide rail bracket are arranged close to a sidewall of the hoistway, the at least one tension member may interfere with the at least one guide rail bracket. Preventing such interference may limit the ability to reduce the dimensions of the elevator system.

It would therefore be beneficial to provide an improved elevator system comprising at least one guide rail bracket that allows for a more compact configuration of the elevator system in which the at least one tension member does not interfere with the at least one guide rail bracket.

### SUMMARY OF THE INVENTION

According to an exemplary embodiment of the invention, an elevator system comprises at least one elevator car that is configured for traveling in a hoistway along a longitudinal direction between a plurality of landings; at least one tension member for supporting and driving the at least one elevator car; and a guiding structure for guiding the movement of the elevator car and/or of a counterweight of the elevator system.

The guiding structure comprises: at least two guide rails provided in the hoistway for guiding the movement of the elevator car in the hoistway; and at least one guide rail bracket that extends along a transverse direction between two of the at least two guide rails for coupling the two guide rails with each other in order to mechanically stabilize the guiding structure. The at least one guide rail bracket comprises a recess that allows the at least one tension member to pass the at least one guide rail bracket by extending through the recess.

Exemplary embodiments of the invention further include a method of installing an elevator machine in an elevator system according to an exemplary embodiment of the invention; wherein the method includes arranging the elevator machine on a bed plate extending between the at least two guide rails; and coupling the at least one tension member to the elevator machine so that the at least one tension member extends through the recess of the at least one guide rail bracket.

An elevator system according to an exemplary embodiment of the invention may comprise a bed plate that extends between the at least two guide rails; and an elevator machine arranged on the bed plate and comprising at least one coupling portion for coupling the elevator machine with the at least one tension member. The elevator machine may be positioned on the bed plate with the at least one coupling member being coupled to the at least one coupling portion such that the at least one tension member extends through the recess of the at least one guide rail bracket.

Exemplary embodiments of the invention allow for compact configurations of the elevator system in which the elevator machine is arranged close to a sidewall of the hoistway and in which the at least one tension member passes the at least one guide rail bracket without interfering with the at least one guide rail bracket.

As a result, exemplary embodiments of the inventions allow for reducing the horizontal dimensions of the elevator system, in particular by arranging the elevator machine closer to an adjacent sidewall of the hoistway, without causing interference between the at least one tension member and the at least one guide rail bracket.

In the following, a number of optional features of an elevator system according to exemplary embodiments of the invention are set out. These features may be realized in particular embodiments, alone or in combination with any of the other features, unless explicitly stated otherwise.

The at least one guide rail bracket may be formed integrally from a single piece of raw material. Forming at least one guide rail bracket integrally from a single piece of raw material may result in a very solid and rigid guide rail bracket that does not comprise any weak areas.

The at least one guide rail bracket may, for example, be made from sheet metal, in particular from a single sheet of metal that is folded for forming the guide rail bracket. Forming the at least one guide rail bracket by folding sheet metal has been found as an efficient way of producing a solid and rigid guide rail bracket at reasonable costs.

The at least one guide rail bracket may comprise a first lateral leg that is attached to a first guide rail of the at least two guide rails; a second lateral leg that is attached to a second guide rail of the at least two guide rails; and a central leg that extends between the first and second lateral legs. The central leg may extend basically perpendicularly to the first and second guide rails.

Such a structure of the at least one guide rail bracket has been found as providing a solid and rigid guide rail bracket that is formed from a relatively small amount of material.

The central leg may comprise a first leg portion that is coupled to the first leg; a second leg portion that is coupled to the second leg; and a recess portion that is arranged between the first and second leg portions and that is set back with respect to the first and second leg portions for forming the recess between the first and second leg portions.

Such a structure of the central leg has been found as efficient for providing a guide rail bracket having a recess that allows at least one tension member to pass through.

When the at least one guide rail bracket is installed within the hoistway of an elevator system, the recess portion may be set back from the at least one elevator car towards an adjacent sidewall of the hoistway, so that the at least one tension member may pass the at least one guide rail bracket on the side facing the elevator car. Such a configuration allows for reducing the dimensions of the elevator system by arranging the elevator machine closer to the adjacent sidewall of the elevator system than in conventional elevator systems comprising guide rails brackets that do not have a recess.

The recess may be set back with respect to the first and second leg portions by 25 mm to 30 mm. Setting back the recess by 25 mm to 30 mm has been found as sufficient for considerably reducing the horizontal dimensions of the elevator system.

At least one of the first and second leg portions may comprise at least one folded portion extending along the transverse direction. In particular, each of the first and second leg portions may comprise at least one folded portion extending along the transverse direction.

At least one folded portion extending along the transverse direction of the first and second leg portions may enhance the mechanical stability of the guide rail bracket.

Each of the first and second leg portions my in particular comprise a first folded portion that is formed at the top of the central leg and a second folded portion that is formed at the bottom of the central leg, respectively. Such a configuration results in a guide rail bracket with very high mechanical stability.

The first and second lateral legs extend basically perpendicularly to the central leg. A guide rail bracket having such a configuration may be mounted to the guide rails very easily and efficiently; resulting in a very strong and stable guiding structure.

The central leg of the guide rail bracket may have a length along the transverse direction between 640 mm and 1240 mm. Lengths in the range of between 640 mm and 1240 mm have been found to be typical lengths in elevator system. The length of a guide rail bracket apparently depends on the positions of the guide rails it is connecting.

The central leg may have a width along a direction that is oriented perpendicularly to the transverse direction between 640 mm and 1240 mm.

A width between 640 mm and 1240 mm. has been found as providing a guide rail bracket that has sufficient stability for stabilizing the guiding structure.

The recess formed in the guide rail bracket may have an extension between 120 mm and 470 mm along the transverse direction.

A recess having an extension between 120 mm and 470 mm along the transverse direction has been found as sufficient for allowing the tensions member(s) of the elevator system to pass by the guide rail bracket without interference.

The extension may depend on the number and on width of the tension members employed in the elevator system.

For enhancing the stability of the guiding structure even further, the elevator system may comprise a plurality of guide rail brackets that are arranged and spaced apart from each other along the longitudinal direction.

The guide rail brackets may, for example, be spaced apart from each other at distances in the range of between 1500 mm and 3180 mm.

The guiding structure may be an elevator car guiding structure in which the at least two guide rails are elevator car guide rails that are configured for guiding the movement of the elevator car along the hoistway.

The elevator system may comprise at least one counterweight that is attached to the at least one tension member for moving concurrently with the at least one elevator car in the opposite direction. Providing the elevator system with a counterweight may allow for reducing the torque that needs to be provided by the elevator machine for driving the elevator car since at least a portion of the weight of the elevator car is compensated by the counterweight.

In an elevator system comprising at least one counterweight, the guiding structure may be a counterweight guiding structure in which the at least two guide rails are counterweight guide rails that are configured for guiding the movement of the counterweight in along hoistway.

Providing the counterweight guiding structure of an elevator system with at least one guide rail bracket according to an exemplary embodiment of the invention may allow for providing an elevator system that comprises at least one counterweight and that is very compact, i.e. that has small dimensions along the horizontal directions.

An elevator system according to a further exemplary embodiment of the invention may comprise a plurality of elevator tension members extending parallel to each other. Employing a plurality of elevator tension members allows for distributing the load of the elevator car and of the counterweight over a plurality of elevator tension members. This provides additional safety due to redundancy. It also allows for reducing the dimensions of each of the plurality of elevator tension members compared to a configuration in which only a single elevator tension member is employed.

The at least one tension member may be a rope, e.g. a steel cord, or a belt, in particular a belt comprising a plurality of steel cords.

The at least one tension member may be uncoated. Alternatively, the at least one tension member may be coated with a coating, e.g. with a coating having the form of a polymer jacket.

The counterweight may be equipped with at least one counterweight pulley for mechanically coupling the counterweight to the at least one elevator tension member. This allows for employing a 2:1 roping in the elevator system.

The elevator car and the counterweight may be coupled to the elevator machine by the at least one elevator tension member employing a 2:1 roping. Employing a 2:1 roping allows for efficiently increasing the force acting on the elevator car and reducing the speed of the elevator car at low costs. This allows for employing a relatively small fast rotating motor in the elevator machine without adding a reduction gear for reducing the rotational speed of the motor. As a result, the costs of the elevator machine may be reduced.

The elevator car may in particular be coupled to the elevator machine by an underslung 2:1 roping, in which a portion of the at least one elevator tension member extends across the bottom of the elevator car between elevator car pulleys mounted to the bottom of the elevator car. An underslung 2:1 roping allows for reducing the space that is needed within the hoistway above the elevator car when the elevator car is located in its uppermost position. In consequence, the length of the hoistway may be used more efficiently when an underslung 2:1 roping is employed.

Exemplary embodiments of the invention may also include elevator systems with ropings that further enhance the forces applied to the elevator car while achieving an even greater reduction in its speed, such as 4:1 ropings. Optionally, these ropings may be underslung ropings as well.

### BRIEF DESCRIPTION OF THE DRAWINGS

In the following, exemplary embodiments of the invention are described in more detail with respect to the enclosed figures:

FIG. 1 depicts a schematic view of an upper portion of an elevator system according to an exemplary embodiment of the invention.

FIG. 2A depicts an enlarged schematic front view of the upper portion of the hoistway adjacent to an upper end of the hoistway.

FIG. 2B depicts a schematic view from the top of the hoistway down into the hoistway.

FIG. 3 depicts a perspective view of an elevator machine support structure according to an exemplary embodiment of the invention supporting an elevator machine.

FIG. 4A depicts a perspective view of an guide rail bracket according to an exemplary embodiment of the invention.

FIG. 4B depicts a plan front view of the guide rail bracket depicted in FIG. 4A.

FIG. 4C depicts a plan side view of the guide rail bracket depicted in FIGS. 4A and 4B.

### DETAILED DESCRIPTION OF THE INVENTION

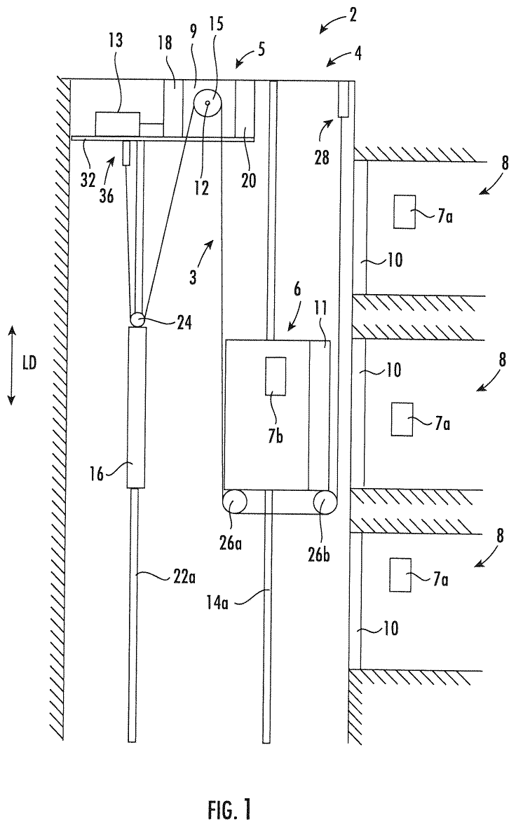

FIG. 1 depicts a schematic side view of an upper portion of an elevator system 2 according to an exemplary embodiment of the invention.

The elevator system 2 depicted in FIG. 1 comprises a hoistway 4 extending in a longitudinal direction L between a plurality of landings 8 located on different floors.

The elevator system 2 includes an elevator car 6 arranged in the hoistway 4 for being moved along the longitudinal direction LD between the plurality of landings 8. The elevator car 6 may in particular be movable along at least one elevator car guide rail 14a provided in the hoistway 4 and extending along the longitudinal direction LD.

The longitudinal direction LD may be oriented in a vertical direction, as it is depicted in FIG. 1. In an alternative embodiment, which is not depicted in the figures, the longitudinal direction LD may be inclined with respect to the vertical direction.

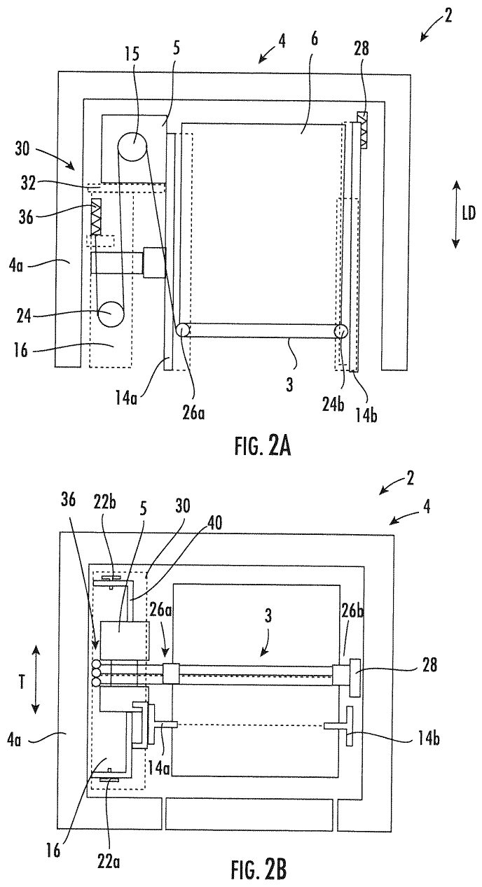

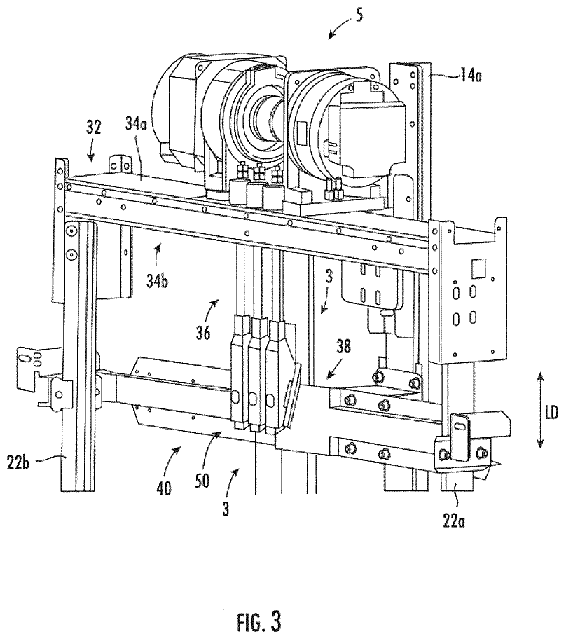

Although only a single elevator car guide rail 14a is visible in FIG. 1, the elevator system 2 may comprise a plurality of elevator car guide rails 14a, 14b (see e.g. FIGS. 2A and 2B) extending parallel to each other within the hoistway 4.

For simplicity of the illustration, only a single elevator car 6 is depicted in FIG. 1. Exemplary embodiments of the invention may, however, also include elevator systems 2 comprising a plurality of elevator cars 6 moving in one or more hoistways 4.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

The elevator car 6 is movably suspended by means of at least one tension member 3.

The at least one tension member 3 may be a rope, e.g. a steel cord, or a belt, in particular a belt comprising a plurality of steel cords (not shown).

The at least one tension member 3 may be uncoated. Alternatively, the at least one tension member 3 may be coated with a coating, e.g. with a coating having the form of a polymer jacket. The at least one tension member 3 may in particular be a belt comprising a plurality of polymer coated steel cords. The elevator system 2 may comprise a plurality of tension members 3 extending parallel to each other.

The at least one tension member 3 is coupled to an elevator machine 5. The elevator machine 5 comprises a motor 9 for rotatably driving a shaft 12, and a drive 18 that harnesses and controls the supply of electrical energy to the motor 9. The elevator machine 5 is configured for driving the at least one tension member 3, which is coupled to the shaft 12, e.g. by a traction sheave 15, in order to move the elevator car 6 in the hoistway 4 along the longitudinal direction LD between the plurality of landings 8.

The elevator machine 5 is provided with at least one elevator brake 20 for braking rotation of the shaft 12 and the traction sheave 15 mounted to the shaft 12 in order to allow for stopping movement of the elevator car 6.

The elevator system 2 further includes a counterweight 16. The counterweight 16 is also coupled to the at least one tension member 3 and configured for moving within the hoistway 4 along at least one counterweight guide rail 22a concurrently and in opposite direction with respect to the elevator car 6.

Although only a single counterweight guide rail 22a is visible in FIG. 1, the elevator system 2 may comprise a plurality of counterweight guide rail 22a, 22b (see e.g. FIGS. 2A and 2B) extending parallel to each other within the hoistway 4.

In the exemplary embodiment of an elevator system 2 depicted in FIG. 1, a 2:1 roping is employed. The skilled person easily understands that different kinds of roping, such as a 4:1 roping, may be employed as well.

The movement of the elevator car 6 along the hoistway 4 between the different landings 8 is controlled by an elevator controller 13.

Input to the elevator controller 13 may be provided via an elevator car control panel 7b provided inside the elevator car 6, and/or via landing control panels 7a provided on every landing 8, in particular in the vicinity of the landing doors 10.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled to the elevator controller 13 by means of electrical wiring not shown in FIG. 1, in particular by an electric bus, or by wireless data connections.

FIG. 2A depicts an enlarged schematic front view of the upper portion of the hoistway 4 adjacent to an upper end of the hoistway 4, and FIG. 2B depicts a schematic view from the top of the hoistway 4 down into the hoistway 4.

FIGS. 2A and 2B show that the elevator car 6 is guided by two elevator car guide rails 14a, 14b extending on both sides of the elevator car 6. In further embodiments, which are not depicted in the figures, the elevator system 2 may comprise more than two elevator car guide rails 14a, 14b.

The counterweight 16 is guided by two counterweight guide rails 22a, 22b extending along the longitudinal direction LD of the hoistway 4.

The two counterweight guide rails 22a, 22b are coupled with each other by at least one guide rail bracket 40 that extends in a transverse direction perpendicularly to the longitudinal direction LD between the two counterweight guide rails 22a, 22b and mechanically connects the two counterweight guide rails 22a, 22b with each other.

As mentioned, in the exemplary embodiment of an elevator system 2 depicted in the figures, a 2:1 roping is employed.

The elevator system 2 comprises a plurality of tensions members 3 extending parallel to each other between a first tension member dead end hitch 36 located below or to the side of the elevator machine 5 on the left side of the hoistway 4 in the FIGS. 2A and 2B, and a second tension member dead end hitch 28 located at the top of the hoistway 4 on the opposite side of the elevator car 6, which is the right side of the hoistway 4 in FIGS. 2A and 2B.

Three tensions members 3 are depicted in FIG. 2B. An elevator system 2 according to an exemplary embodiment of the invention may comprise more or fewer than three tension members 3. An elevator system 2 according to an exemplary embodiment of the invention may in particular comprise only a single tension member 3.

Each of the tension members 3 extends from the first tension member dead end hitch 36 down to a counterweight pulley 24 provided at the counterweight 16. The counterweight pulley 24 changes the direction of the tension members 3 so that the tension members 3 extend further upwards from the counterweight 16 to the traction sheave 15 of the elevator machine 5 located at the upper end of the hoistway 4.

The traction sheave 15 again changes the direction of the tension members 3, causing the tension members 3 to extend downwards again to first elevator car pulleys 26a that are mounted to the bottom of the elevator car 6.

Each tension member 3 is deflected by a corresponding first elevator car pulley 26a in order to extend basically horizontally below the bottom of the elevator car 6 to a second elevator car pulley 26b that is mounted to the bottom of the elevator car 6 on an opposite side of the elevator car 6.

The second elevator car pulleys 26b deflect the respective tension members 3 upwards towards the second tension member dead end hitch 28 provided at the upper end of the hoistway 4.

The elevator car 6 and the counterweight 16 may be moved concurrently and in opposite directions along the longitudinal extension of the hoistway 4 by rotating the shaft 12 and the traction sheave 15 mounted to the shaft 12.

The elevator machine 5 and the first tension member dead end hitch 36 are supported within the hoistway 4 by an elevator machine support structure 30.

In order to reduce the horizontal space that is occupied by the elevator machine 5 and the elevator machine support structure 30 in the hoistway 4 and for avoiding the need of cutting an upper end of the elevator car guide rails 14a, 14b for providing sufficient space for the elevator machine 5, it may be desirable to move the elevator machine 5 horizontally away from the elevator car 6 towards the adjacent sidewall 4a of the hoistway 4.

When the elevator machine 5 is moved away from the elevator car 6 towards the adjacent sidewall 4a of the hoistway 4, there is a risk that the tension members 3 interfere with the at least one guide rail bracket 40 extending between the two counterweight guide rails 22a, 22b.

According to an exemplary embodiment of the invention, a recess 38 is formed in the at least one guide rail bracket 40 that allows the at least one tension member 3 to extend through said recess 38 when it passes the at least one guide rail bracket 40. As a result, the tension members 3 do not interfere with the at least one guide rail bracket 40.

FIG. 3 depicts a perspective view of the upper ends of the counterweight guide rails 22a, 22b with an elevator machine support structure 30 and a guide rail bracket 40 according to an exemplary embodiment of the invention.

The elevator machine support structure 30 comprises a bed plate 32 supporting the elevator machine 5.

The bed plate 32 is provided as a hollow profile comprising an upper horizontal wall 34a and an opposing lower horizontal wall 34b extending parallel to each other. The elevator machine 5 is arranged on the upper horizontal wall 34a.

A first tension member dead end hitch 36 extends from the lower horizontal wall 34b of the bed plate 32 facing downwards. The first tension member dead end hitch 36 comprises one or more tension member termination and fixing devices 50 such as wedge clamps, that are configured for receiving and fixing the ends of the tension members 3.

In some distance below the elevator machine support structure 30, the two counterweight guide rails 22a, 22b are connected with each other by a guide rail bracket 40.

The guide rail bracket 40 may, for example, be arranged in a distance of between 300 mm and 450 mm below the bed plate 32.

Although only a single guide rail bracket 40 is depicted in FIG. 3, the elevator system 2 may comprise a plurality of guide rail brackets 40 that are arranged and spaced apart from each other along the longitudinal direction LD.

The guide rail brackets 40 may, for example, be spaced apart from each other at distances between 1500 mm and 3180 mm.

FIG. 3 further shows that the tension members 3 extending downwards from the traction sheave 15 of the elevator machine 5 pass through a recess 38 that is formed in a central portion of the guide rail bracket 40 without interfering with the guide rail bracket 40.

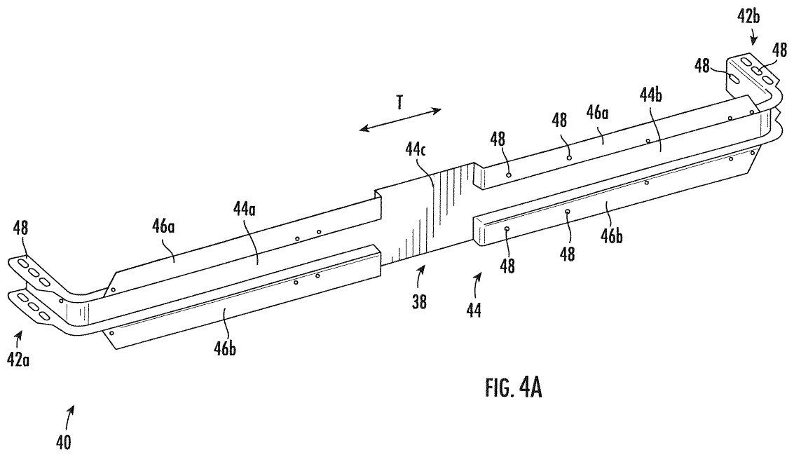

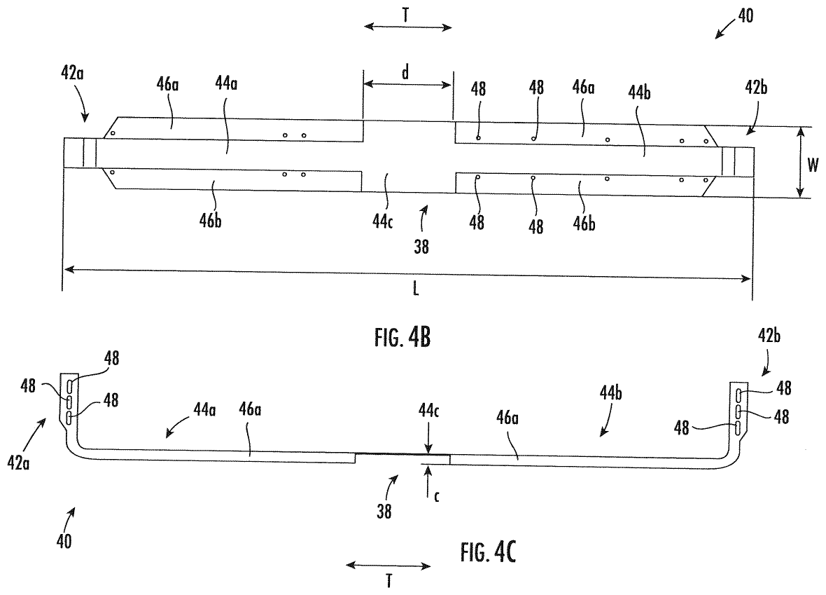

FIG. 4A depicts a perspective view of a guide rail bracket 40 according to an exemplary embodiment of the invention. FIG. 4B depicts a planar front view of the guide rail bracket 40 depicted in FIG. 4A, and FIG. 4C depicts a planar side view thereof.

The guide rail bracket 40 depicted in FIGS. 4A to 4C comprises a first lateral leg 42a that is configured for being attached to a first counterweight guide rail 22a of the two counterweight guide rails 22a, 22b; a second lateral leg 42b hat is configured for being attached to a second counterweight guide rail 22b of the counterweight guide rails 22a, 22b, and a central leg 44 that extends between the first and second lateral legs 42a, 42b. The first and second lateral legs 42a, 42b extend basically perpendicularly to the central leg 44.

The central leg 44 may have a length L along the transverse direction T in the range of between 640 mm and 1240 mm. The central leg 44 may have a width W along a direction that is oriented perpendicularly to the transverse direction T in the range of between 140 mm and 170 mm.

A plurality of openings 48 may be formed in the first and second lateral legs 42a, 42b and in the central leg 44, respectively. The openings 48 allow for fixing the guide rail bracket 40 to the counterweight guide rails 22a, 22b using fixing means (not shown), such as bolts, rivets or screws that extend through at least some of the openings 48.

The central leg 44 comprises a first leg portion 44a coupled to the first lateral leg 42a, a second leg portion 44b coupled to the second lateral leg 42b, and a recess portion 44c that is arranged between and coupled with the first and second leg portions 44a, 44b. The recess portion 44c is set back with respect to the first and second leg portions 44a, 44b forming the recess 38 between the first and second leg portions 44a, 44b.

The recess may have an extension d (see FIG. 4B) along the transverse direction T that is in the range of between 120 mm and 470 mm.

The recess portion 44c may be set back with respect to the first and second portions 44a, 44b by a distance c (see FIG. 4C) of 25 mm to 30 mm.

When the guide rail bracket 40 is mounted to the counterweight guide rails 22a, 22b, as it is depicted in FIG. 3, the recess portion 44c is set back from the at least one elevator car 6 towards an adjacent sidewall 4a (see FIG. 2B) of the hoistway 4 and allows the at least one tension member 3 to pass the at least one guide rail bracket 40 on the side facing the elevator car 6.

The guide rail bracket 40 may be formed integrally from a single piece of raw material. The guide rail bracket 40 may, for example, be made of sheet metal, in particular of a single sheet of metal that has been folded for forming the guide rail bracket 40.

In the embodiment depicted in FIGS. 4A to 4C, each of the first and second leg portions 44a, 44b comprises at least one folded portion 46a, 46b extending along the transverse direction T.

Each of the first and second leg portions 44a, 44b comprises in particular a first folded portion 46a that is formed at the top of the respective central leg portion 44a, 44b and a second folded portion 46b that is formed at the bottom of the respective central leg portion 44a, 44b, respectively. The recess portion 44c is not provided with a folded portion.

The folded portions 46a, 46b allow for enhancing the mechanical stability and rigidity of the central leg 44.

Although a guide rail bracket 40 according to an exemplary embodiment of the invention has been described with reference to the figures as being mounted to two counterweight guide rails 22a, 22b, a guide rail bracket 40 according to an exemplary embodiment of the invention may similarly extend between two elevator car guide rails 14a, 14b for allowing at least one tension member 3 extending along the elevator car guide rails 14a, 14b to pass the guide rail bracket 40.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. Elevator system (2) comprising:
at least one elevator car (6) that is configured for traveling in a hoistway (4) along a longitudinal direction (LD) between a plurality of landings (8);
at least one tension member (3) for supporting and driving the at least one elevator car (6); and
a guiding structure comprising:
at least two guide rails (14a, 14b; 22a, 22b) provided in the hoistway (4) for guiding the movement of the elevator car (6) and/or of a counterweight (16) in the hoistway (4); and
at least one guide rail bracket (40) extending along a transverse direction between two of the at least two guide rails (14a, 14b; 22a, 22b) for coupling two guide rails (14a, 14b; 22a, 22b) with each other;
wherein the at least one guide rail bracket (40) comprises a recess (38) that allows the at least one tension member (3) to pass the at least one guide rail bracket (40) by extending through the recess (38).

2. Elevator system (2) according to claim 1, wherein the at least one guide rail bracket (40) is formed from sheet metal, in particular from folded sheet metal.

3. Elevator system (2) according to claim 1, wherein the at least one guide rail bracket (40) comprises:
a first lateral leg (42a) that is attached to a first guide rail (16a, 22a) of the at least two guide rails (14a, 14b; 22a, 22b);
a second lateral leg (42b) that is attached to a second guide rail (16b, 22b) of the at least two guide rails (14a, 14b; 22a, 22b); and
a central leg that extends between the first and second lateral legs (42a, 42b); and
wherein the central leg (44) extends in particular basically perpendicularly to the first and second guide rail (14a, 14b; 22a, 22b).

4. Elevator system (2) according to claim 3, wherein the central leg comprises:
a first leg portion (44a) coupled to the first lateral leg (42a);
a second leg portion (44b) coupled to the second lateral leg (42b); and
a recess portion (44c) that is arranged between the first and second leg portions (44a, 44b) and that is set back with respect to the first and second leg portions (44a, 44b) for forming the recess (38) between the first and second leg portions 44b).

5. Elevator system (2) according to claim 4, wherein the recess portion (44c) is set back from the at least one elevator car (6) towards an adjacent sidewall of the hoistway (4).

6. Elevator system (2) according to claim 4, wherein the recess (38) is set back with respect to the first and second leg portions (44a, 44b) by a distance c of 25 mm to 30 mm.

7. Elevator system (2) according to claim 4,
wherein at least one of the first and second leg portions (44a, 44b) comprises at least one folded portion (46a, 46b) extending along the transverse direction;
wherein each of the first and second leg portions (44a, 44b) comprises in particular a first folded portion (46a) that is formed at a top portion of the central leg (44) and a second folded portion (46b) that is formed at an opposing bottom portion of the central leg (44), respectively.

8. Elevator system (2) according to claim 3, wherein the first and second lateral legs (42a, 42b) extend basically perpendicularly to the central leg (44).

9. Elevator system (2) according to claim 3,
wherein the central leg (44) has a length (L) along the transverse direction (T) in the range of between 640 mm and 1240 mm; and/or
wherein the central leg has a width (W) along a direction that is oriented perpendicularly to the transverse direction (L) in the range of between 140 mm and 170 mm.

10. Elevator system (2) according to claim 1, wherein the recess (38) has an extension d in the range of between 120 mm and 470 mm along the transverse direction.

11. Elevator system (2) according to claim 1, further comprising a plurality of guide rail brackets (40) that are arranged and spaced apart from each other along the longitudinal direction (L);
wherein the guide rail brackets (40) are in particular spaced apart from each other at distances in the range of between 1500 mm and 3180 mm.

12. Elevator system (2) according to claim 1, further comprising at least one counterweight (16) that is attached to the at least one tension member (3) for moving concurrently with the at least one elevator car (6) in the opposite direction.

13. Elevator system (2) according to claim 12, wherein the guiding structure is a counterweight guiding structure in which the at least two guide rails (14a, 14b; 22a, 22b) are counterweight guide rails (22a, 22b) that are configured for guiding the movement of the counterweight (16) along the hoistway (4).

14. Elevator system (2) according to claim 1, further comprising:
a bed plate (32) extending between the at least two guide rails (14a, 14b; 22a, 22b); and
an elevator machine (5) arranged on the bed plate (32) and comprising at least one coupling portion for coupling the elevator machine (5) with the at least one tension member (3);
wherein the elevator machine (5) is positioned on the bed plate (32) with the at least one tension member (3) being coupled to the at least one coupling portion of the elevator machine (5) such that the at least one tension member (3) extends through the recess (38) of the at least one guide rail bracket (40).

15. Method of installing an elevator machine (5) in an elevator system (2) according to claim 1; wherein the method includes
arranging the elevator machine (5) on a bed plate (32) extending between the at least two guide rails (14a, 14b; 22a, 22b); and
coupling the at least one tension member (3) to the elevator machine (5) so that the at least one tension member (3) extends though the recess (38) of the at least one guide rail bracket (40).
